(19) United States
(12) Patent Application Publication
(10) Pub. No.: US 2009/0052027 A1
(43) Pub. Date: Feb. 26, 2009

(54) SPACIAL IMAGE DISPLAY

(76) Inventors: Masahiro Yamada, Kanagawa (JP); Sunao Aoki, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/193,990

(22) Filed: Aug. 19, 2008

(30) Foreign Application Priority Data
Aug. 22, 2007 (JP) P2007-216399

(51) Int. Cl. G02B 27/22

(52) U.S. Cl. 359/463

(57) ABSTRACT

When a two-dimensional display section including a plurality of pixels of p colors and a lenticular lens slanted with respect to a pixel array are combined to emit a plurality of light rays corresponding to a plurality of viewing angles into space by surface segmentation at the same time. Moreover, relative positional relationship between each cylindrical lens and each pixel of the two-dimensional display section is periodically changed to periodically displace the emission direction of display image light from each pixel via each cylindrical lens. Images corresponding to a unit frame of a three-dimensional image are time-divisionally displayed on the two-dimensional section, and a timing of time-divisional display in the two-dimensional display section 1 and a timing for changing relative positional relationship are synchronously controlled. Thereby, stereoscopic display with higher definition using a combination of a surface segmentation system and a time-division system is performed.

### CROSS REFERENCES TO RELATED APPLICATIONS

The present invention contains subject matter related to Japanese Patent Application JP 2007-216399 filed in the Japanese Patent Office on Aug. 22, 2007, the entire contents of which being incorporated herein by reference.

### BACKGROUND OF THE INVENTION

1. Field of the Invention

The present invention relates to an apparatus performing three-dimensional display by displaying a spacial image, in particular to a spacial image display including at least a two-dimensional display and a lenticular lens.

2. Description of the Related Art

Binocular stereoscopic displays which achieve a stereoscopic vision by displaying images with parallax to both eyes of a viewer have been known. On the other hand, as human stereoscopic perception functions, four functions, that is, binocular disparity, convergence, physiological accommodation and motion parallax are known; however, in the binocular stereoscopic displays, binocular disparity is satisfied, but inconsistency or contradiction in recognition between binocular disparity and other perception functions often occurs. Such inconsistency or contradiction does not occur in the real world, so it is said that the viewer's brain is confused to become fatigued.

Therefore, as a method of achieving more natural stereoscopic vision, the development of a spacial image system has been proceeding. In the spacial image system, a plurality of light rays with different emission directions are emitted into space to form a spacial image corresponding to a plurality of viewing angles. The spacial image system is capable of satisfying binocular disparity, convergence and motion parallax in the human stereoscopic perception functions. In particular, if a suitable image for each of viewing angles separated at fine intervals is able to be displayed in space, all of the stereoscopic perception functions including physiological accommodation as a human focusing function are able to be satisfied, and a natural stereoscopic image is able to be perceived. As a method of forming a spacial image, there is known a display method using a “time division system” in which images corresponding to a plurality of viewing angles are switched and time-divisionally displayed at high speed. As a method achieving the time division system, for example, a method using a deflection micromirror array formed through the use of an MEMS (Micro Electro Mechanical System) technique is known. In the method, time-divided image light is deflected by the deflection micromirror array in synchronization with the timing of image switching.

As the spacial image system, a system including a combination of a two-dimensional display such as a liquid crystal display and a lenticular lens is also known (refer to Yuzo Hirayama, “flat-bed type 3D display system”, Kogaku, Vol. 35, 2006, p. 416-422, Y. Takaki, “Density directional display for generating natural three-dimensional images”, Proc.IEEE, 2006, Vol. 94, p. 654-663, U.S. Pat. No. 6,064,424, and Japanese Unexamined Patent Application Publication No. 2005-309374). In this system, images corresponding to a plurality of viewing angles are packed in one display surface of a two-dimensional display to be displayed at a time, and the image corresponding to a plurality of viewing angles are deflected in an appropriate direction through a lenticular lens to be emitted, thereby a spacial image corresponding to a plurality of viewing angles is formed. Unlike the above-described time division system, in the system, images corresponding to a plurality of viewing angles in one display surface are segmented, and the images are displayed at a time, so it is called a “surface segmentation system”.

In this case, the lenticular lens includes a plurality of cylindrical lenses arranged in parallel so that cylindrical axes (central axes) of the cylindrical lenses are substantially parallel to one another, and has a sheet shape (a plate shape) as a whole. In the above-described surface segmentation system, the focal planes of the cylindrical lenses constituting the lenticular lens are adjusted to coincide with the display surface of the two-dimensional display. As the simplest combination of the two-dimensional display and the lenticular lens, there is a method of setting the cylindrical axes of the cylindrical lenses and the horizontal direction of the two-dimensional display to be parallel to each other. In this method, typically, the display surface of the two-dimensional display includes a large number of pixels arranged in a horizontal direction and a vertical direction, so a predetermined plural number of pixels arranged in a horizontal direction corresponding to one cylindrical lens constitute “a three-dimensional pixel”. The “three-dimensional pixel” is one unit of pixel for displaying a spacial image, and a pixel group including a predetermined plural number of pixels in the two-dimensional display is set as one “three-dimensional pixel”. As a horizontal distance from the cylindrical axis of the cylindrical lens to each pixel determines a horizontal traveling direction (a deflection angle) of light emitted from the pixel after the light passes through the cylindrical lens, a number of horizontal display directions equal to the number of horizontally-arranged pixels used as the three-dimensional pixel are obtained. In this configuration method, there is an issue that when the number of horizontal display directions is increased, horizontal resolution of a three-dimensional display is considerably reduced, and an imbalance between horizontal resolution and vertical resolution of the three-dimensional display occurs. In U.S. Pat. No. 6,064,424, to solve this issue, a method of slanting the cylindrical axes of the cylindrical lenses with respect to the horizontal direction of the two-dimensional display is proposed.

FIG. 19A shows an example of a display system proposed in U.S. Pat. No. 6,064,424. In FIG. 19A, a two-dimensional display 101 includes a plurality of pixels 102 of three colors R, G and B. The pixels 102 of the same color are arranged in a horizontal direction, and the pixels 102 of three colors R, G and B are periodically arranged in a vertical direction. The lenticular lens 103 includes a plurality of cylindrical lenses 104. The lenticular lens 103 is arranged so as to be slanted with respect to the vertical arrangement direction of pixels 102. In the display system, a total number M×N of pixels 102 including a number M of pixels 102 in a horizontal direction and a number N of pixels 102 in a vertical direction, constitute one three-dimensional pixel to achieve a number M×N of horizontal display directions. At this time, assuming that the slanted angle of the lenticular lens 103 is θ, when θ=tan⁻¹(px/Npy) is established, the horizontal distances of all pixels 102 in the three-dimensional pixel with respect to the cylindrical axes of the cylindrical lenses 104 are able to be set to values different from one another. In this case, px is a pitch in a horizontal direction of pixels 102 of the colors, and py is a pitch in a vertical direction of pixels 102 of the colors.

In the example shown in FIG. 19A, where N=2, and M=7/2, 7 pixels 102 are used to constitute one three-dimensional pixel, thereby 7 horizontal display directions are achieved. In FIG. 19A, reference numerals 1 to 7 designating the pixels 102 correspond to 7 horizontal display directions. It is proposed that when the lenticular lens 103 slanted in such a manner is used, one three-dimensional pixel is able to be constituted by not only pixels 102 in a horizontal direction but also pixels 102 in a vertical direction, and a decline in the resolution in a horizontal direction of the three-dimensional display is able to be reduced, and a balance between horizontal resolution and vertical resolution is able to be improved.

However, in the display system shown in FIG. 19A, the pixels 102 of only one color in one three-dimensional pixel correspond to one horizontal display direction. Therefore, in one three-dimensional pixel, it is difficult to display three primary colors of R, G and B in one horizontal display direction at the same time. Therefore, 3 three-dimensional pixels are combined to display three primary colors of R, G and B in one horizontal display direction at the same time. In FIG. 19B, a display color in the fourth horizontal display direction of 7 horizontal display directions is shown in each three-dimensional pixel. As shown in FIG. 19B, when 3 three-dimensional pixels in a slanted direction are combined to be used, three primary colors of R, G and B are displayed in one horizontal display direction at the same time, thereby full-color display is achieved. In this display system, the display color of the three-dimensional pixel is changed in a horizontal display direction, so an issue that color unevenness in a three-dimensional image occurs is indicated. Moreover, the maximum intensity is changed with respect to a horizontal display direction depending on the pixel configuration of pixels 102 of each color, so there is an issue that intensity unevenness in a horizontal direction occurs in a retinal image. In Japanese Unexamined Patent Application Publication No. 2005-309374, there is proposed a method of overcoming the issues in the display system shown in U.S. Pat. No. 6,064,424 by devising the arrangement of pixels 102 or the slanted angle θ of the lenticular lens 103.

### SUMMARY OF THE INVENTION

However, in a spacial image display using a time division system in related arts, there is an issue that it is difficult to achieve a large-area display in terms of costs and manufacturing aptitude. Moreover, there is an issue that, for example, in the case where a deflection micromirror array is used, to precisely deflect all micromirrors in synchronization with one another, it is necessary to independently control the micromirrors with high precision, but it is difficult to control the micromirrors.

Further, in a spacial image display using a surface segmentation system in related arts, it is characterized that three-dimensional information (images corresponding to a large number of viewing angles) is packed in a display surface of a two-dimensional display at the same time. Three-dimensional information is packed in the limited number of pixels of the two-dimensional display, so the definition of a three-dimensional image (a spacial image) to be displayed is lower than the definition of a two-dimensional image which is allowed to be displayed by the two-dimensional display. Moreover, there is an issue that an attempt to increase a region where a spacial image is viewable or an attempt to display a natural and smooth spacial image with respect to the motion of a viewer causes a considerable decline in the definition, compared to the definition of the two-dimensional display. To avoid this issue, there is considered a method of switching and time-divisionally displaying images of the two-dimensional display including slightly different three-dimensional information at high speed through the use of an integral effect of human eyes. This method is considered as a display method using a combination of the time division system and the surface segmentation system; however, a specific technique to practically achieving the method has not been developed yet.

In view of the foregoing, it is desirable to provide a spacial image display capable of easily achieving stereoscopic display with higher definition than before.

According to an embodiment of the invention, there is provided a spacial image display emitting, into space, a plurality of light rays corresponding to a plurality of viewing angles to form a three-dimensional spacial image, the spacial image display including: a two-dimensional display section including a plurality of pixels of p colors (p is an integer of 1 or more), the pixels being two-dimensionally arranged on a lattice in a horizontal direction and a vertical direction to form a planar display surface, a plurality of pixels of the same color being arranged in the horizontal direction, a plurality of pixels of p colors being periodically arranged in the vertical direction so that the same color appears at a certain period; a lenticular lens, with a plate shape as a whole, including a plurality of cylindrical lenses arranged in parallel so that cylindrical axes of the cylindrical lenses are parallel (substantially parallel) to one another, the lenticular lens facing a display surface of the two-dimensional display section so as to be parallel (substantially parallel) to the display surface as a whole, the cylindrical axes of the cylindrical lenses being slanted at a predetermined angle with respect to an axis in the horizontal direction of the two-dimensional display section in a plane parallel (substantially parallel) to the display surface, each of the cylindrical lenses deflecting display image light from each pixel of the two-dimensional display section to emit the display image light; a displacement means for reciprocating at least one of the lenticular lens and the two-dimensional display section in a plane parallel to the display surface to periodically change relative positional relationship between each of the cylindrical lenses and each of the pixels of the two-dimensional display section, thereby to periodically displace the emission direction of display image light from each pixel via each of the cylindrical lenses; and a control means for controlling images corresponding to a unit frame of a three-dimensional image to be time-divisionally displayed on the two-dimensional display section, and controlling a timing of time-divisional display to be synchronized with a timing for changing the relative positional relationship by the displacement means.

In the spacial image display according to the embodiment of the invention, when the two-dimensional display section including a plurality of pixels of p colors and the lenticular lens slanted with respect to a pixel array are combined, a plurality of light rays corresponding to a plurality of viewing angles are emitted into space by surface segmentation at the same time. Moreover, relative positional relationship between each cylindrical lens and each pixel of the two-dimensional display section is periodically changed to periodically displace the emission direction of display image light from each pixel via each cylindrical lens. Then, images corresponding to a unit frame of a three-dimensional image are time-divisionally displayed on the two-dimensional display section, and a timing of time-divisional display in the two-dimensional display section and a timing for changing the relative positional relationship by the displacement means are synchronously controlled. In other words, in the spacial image display according to the embodiment of the invention, stereoscopic display using a combination of a surface segmentation system and a time division system is performed. Thereby, stereoscopic display with higher definition than that in a related art is achieved.

In the spacial image display according to the embodiment of the invention, it is preferable that a pixel group, formed from a N by p×M matrix of pixels and including a total number p×M×N of pixels, configures a three-dimensional pixel, where N and M are integers of 1 or more which represent numbers of pixels arranged in the vertical direction and the horizontal direction in the two-dimensional display section, respectively, and an angle between the vertical direction in the two-dimensional display section and a direction of the cylindrical axis of the lenticular lens satisfies an expression (A):

θ=tan⁻¹{(p×px)/(n×N×py)} (A)

where n is an integer of 1 or more, px is a pixel pitch in the horizontal direction of the two-dimensional display section, and py is a pixel pitch in the vertical direction of the two-dimensional display section. The expression is not necessarily strictly satisfied, and it is only necessary to roughly satisfy the expression within a range where appropriate target display quality is satisfied.

In particular, it is preferable that the displacement means allows the lenticular lens or the two-dimensional display section to be reciprocated in the horizontal direction of the two-dimensional display section, a value n×N in the expression (A) is an integral multiple of p and, the control means changes relative positional relationship xij between each of the cylindrical lenses and each pixel of the two-dimensional display section according to an expression (1), and controls a timing of time-divisional display in the two-dimensional display section to synchronized with a timing for displacing a relative positional relationship xij:

xij=xo+b0×i+a0×j (1)

where

xo is a relative reference position between the lenticular lens and the two-dimensional display section,

i=0, . . . , (m−1), where m is an integer of 1 or more,

j=0, . . . , (n−1), where n is an integer of 1 or more,

a0=(p×px)/n and

b0=a0/(N×m)

The expression is not necessarily strictly satisfied, and it is only necessary to roughly satisfy the expression within a range where appropriate target display quality is satisfied.

Alternatively, in particular, it is preferable that the displacement means allows the lenticular lens or the two-dimensional display section to be reciprocated in the horizontal direction of the two-dimensional display section, a value n×N in the expression (A) is not an integral multiple of p, and the control means displaces relative positional relationship xij between each of the cylindrical lenses and each pixel of the two-dimensional display section according to an expression (2), and controls a timing of time-divisional display in the two-dimensional display section to be synchronized with a timing for changing the relative positional relationship xij:

xij=xo+b0×i+a0×j (2)

where

xo is a relative reference position between the lenticular lens and the two-dimensional display section,

i=0, . . . , (m−1), where m is an integer of 1 or more,

j=0, . . . , (n−1), where n is an integer of 1 or more,

a0=(p×px)/n

b0=px

m=p

The expression is not necessarily strictly satisfied, and it is only necessary to roughly satisfy the expression within a range where appropriate target display quality is satisfied.

When appropriate control is performed so that such predetermined expressions are satisfied, intensity variations in the brightness of a spacial image and color unevenness are prevented, and spacial image display is performed more favorably.

In the spacial image display according to the embodiment of the invention, the two-dimensional display section including a plurality of pixels of p colors and the lenticular lens slanted with respect to a pixel array are appropriately combined to emit a plurality of light rays corresponding to a plurality of viewing angles into space by surface segmentation, and relative positional relationship between each cylindrical lens of the lenticular lens and each pixel of the two-dimensional display section is periodically changed to periodically displace the emission direction of display image light from each pixel via each cylindrical lens, thereby images corresponding to a unit frame of a three-dimensional image are time-divisionally displayed on the two-dimensional display section, and a timing of time-divisional display in the two-dimensional display section and a timing for changing the relative positional relationship are synchronously controlled, so stereoscopic display using a combination of a surface segmentation system and a time division system is able to be achieved. Moreover, the lenticular lens or the two-dimensional display section is moved as a whole to achieve time-divisional display; therefore, for example, compared to the case where micromirrors of a deflection micromirror array are time-divisionally, independently and synchronously controlled, synchronous control is easier. Thereby, stereoscopic display with higher definition than that in the related art is able to be easily achieved.

Other and further objects, features and advantages of the invention will appear more fully from the following description.

### BRIEF DESCRIPTION OF THE DRAWINGS

FIG. 1 is an external view showing a schematic configuration of a spacial image display according to a first embodiment of the invention with a state of light rays emitted from one three-dimensional pixel;

FIG. 2 is an illustration showing the state of the light rays shown in FIG. 1 when viewed from above;

FIG. 3 is a block diagram showing the whole configuration of the spacial image display according to the first embodiment of the invention;

FIG. 4 is a schematic view for describing an example of a method of forming video signals;

FIG. 5 is an illumination showing arrangement lines of pixels of a two-dimensional display section and an arrangement example of a lenticular lens in the spacial image display according to the first embodiment of the invention;

FIG. 6 is an illustration showing an operation example of relative movement between the two-dimensional display section and the lenticular lens in a three-dimensional frame period by time division in the case where attention is focused on pixels of red;

FIGS. 7A and 7B are a bird's eye view and a lateral sectional view for describing the deflection angle of a light ray from an arbitrary light-emitting point (a pixel);

FIG. 8 is an illustration of a distance xs between the arbitrary light-emitting point and a line Y′ formed by projecting a central line (a cylindrical axis) Y1 of a cylindrical lens onto a display surface;

FIG. 9 is a bird's eye view for describing a relationship between deflection angles φ and φ′ of a light ray;

FIGS. 10A, 10B and 10C are illustrations for describing a relationship between the deflection angles φ and φ′ of the light ray, FIG. 10A is a top view when viewing the light ray from a direction perpendicular to the display surface, FIG. 10B is a side view when viewing the light ray from a horizontal direction (a Y direction) of the display surface, and FIG. 10C is a side view when viewing emission from a central axis direction (a Y′ direction) of the cylindrical lens;

FIG. 11 is an illustration showing a more specific display state at a timing T9 in FIG. 6;

FIG. 12 is an illustration showing a first example of a relationship between a relative displacement amount between the two-dimensional display section and the lenticular lens and the timing of the relative movement for achieving the operation shown in FIG. 6;

FIG. 13 is an illustration showing a second example of a relationship between a relative displacement amount between the two-dimensional display section and the lenticular lens and the timing of the relative movement for achieving the operation shown in FIG. 6;

FIG. 14 is an illustration showing a state in which color unevenness is reduced;

FIG. 15 is an enlarged illustration showing display states at timings T1, T4 and T7 in FIG. 14;

FIG. 16 is an enlarged illustration showing display states at timings T2, T5 and T8 in FIG. 14;

FIG. 17 is an enlarged illustration showing display states at timings T3, T6 and T9 in FIG. 14;

FIGS. 18A and 18B are illuminations showing a display example of a spacial image display according to a second embodiment of the invention; and

FIGS. 19A and 19B are a plan view showing an example of a stereoscopic display in a related art including a combination of a two-dimensional display and a lenticular lens and an illustration showing a state of pixels displayed in one display direction, respectively.

### DETAILED DESCRIPTION OF THE PREFERRED EMBODIMENTS

Preferred embodiments will be described in detail below referring to the accompanying drawings.

### First Embodiment

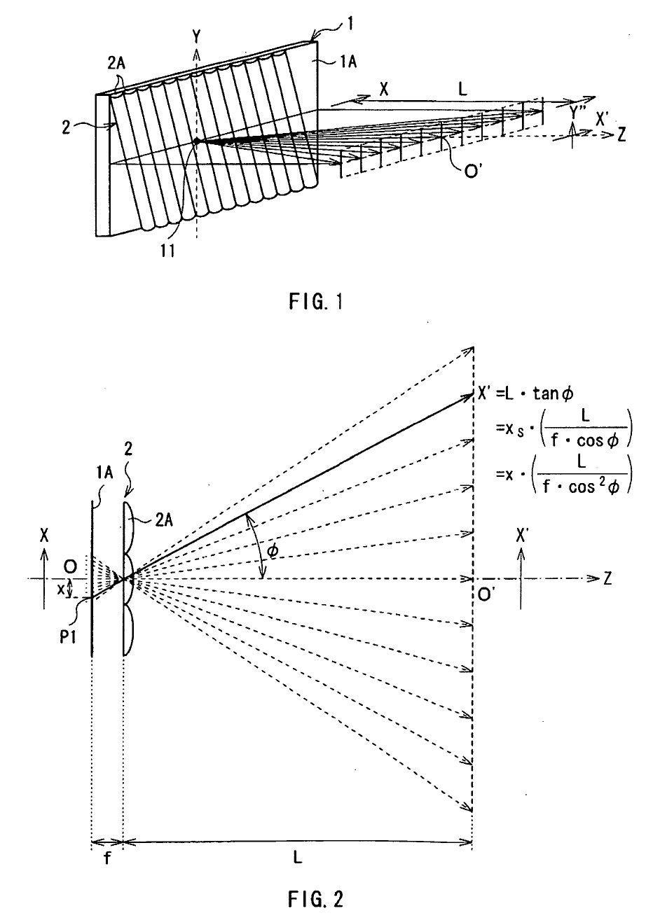

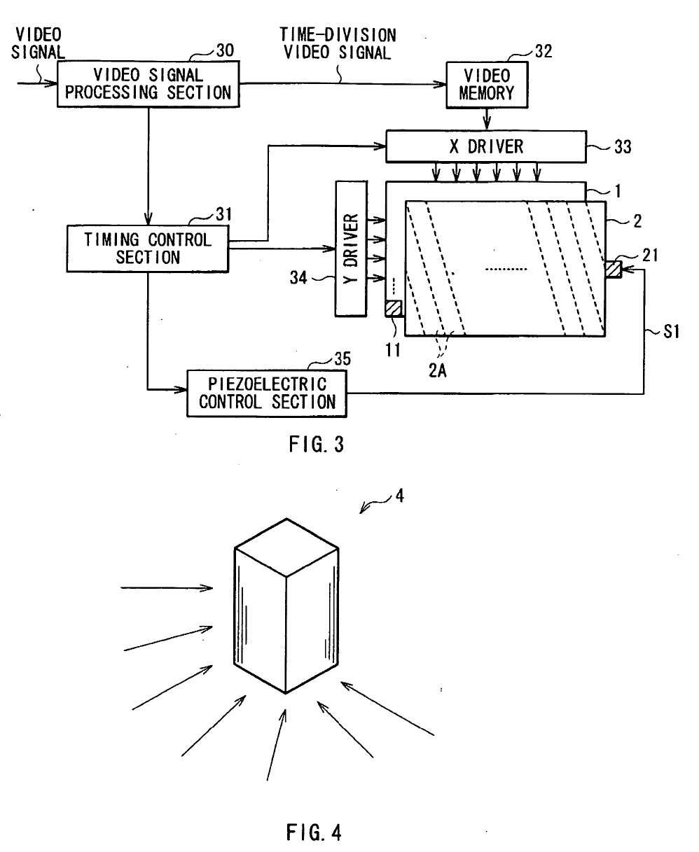

FIG. 1 shows an external view of a schematic configuration of a spacial image display according to a first embodiment of the invention. FIG. 1 also shows a state of light rays emitted from a pixel (a three-dimensional pixel 11). FIG. 2 shows the state of the light rays when viewed from above. FIG. 3 shows the whole configuration of the spacial image display including circuit elements according to the embodiment.

The spacial image display according to the embodiment includes a two-dimensional display and a lenticular lens 2. The two-dimensional display includes, for example, a two-dimensional display section 1 configured of a display device such as a liquid crystal display panel. The lenticular lens 2 includes a plurality of cylindrical lenses 2A arranged in parallel so that the cylindrical axes thereof are substantially parallel to one another, and has a plate shape as a whole. The lenticular lens 2 faces a display surface 1A of the two-dimensional display section 1 so that they are substantially parallel to each other as a whole. Moreover, the focal plane of each cylindrical lens 2A faces the display surface 1A of the two-dimensional display section 1 so as to coincide with the display surface 1A. Further, the lenticular lens 2 is arranged so that the cylindrical axes of the cylindrical lenses 2A are slanted with respect to a horizontal direction (a Y direction) of the two-dimensional display section 1. The lenticular lens 2 deflects display image light from the two-dimensional display section 1 in each pixel to emit the display image light.

The two-dimensional display section 1 includes a plurality of pixels 10 of p kinds (p colors (p is an integer of 1 or more)), and the pixels 10 are two-dimensionally arranged on a lattice in a horizontal direction (a Y direction) and a vertical direction (an X direction) to form a planar display surface 1A. In the two-dimensional display section 1, a plurality of pixels 10 of the same color are arranged in the horizontal direction, and a plurality of pixels 10 of p colors are periodically arranged in the vertical direction so that the same color appears at a certain period. As such a two-dimensional display section 1, for example, a liquid crystal display device may be used. The liquid crystal display device has a configuration (not shown) in which a pixel electrode formed in each pixel 10 is sandwiched between a pair of glass substrates. Moreover, a liquid crystal layer or the like (not shown) is further arranged between the pair of glass substrates.

FIG. 5 more specifically shows arrangement lines of pixels 10 of the two-dimensional display section 1 and an arrangement example of the lenticular lens 2. The two-dimensional display section 1 and the lenticular lens 2 are arranged so that an angle formed by a line segment (a line segment parallel to the Y direction) passing through the center of a column including the pixels 10 of the same color of the two-dimensional display section 1 and a line segment parallel to a cylindrical axis Y1 of the lenticular lens 2 satisfies an expression (A):

θ=tan⁻¹{(p×px)/(n×N×py)} (A)

where n is an integer of 1 or more.

The expression is not necessarily strictly satisfied, and it is only necessary to roughly satisfy the expression within a range where appropriate target display quality is satisfied.

In an example shown in FIG. 5, pixels 10 of the two-dimensional display section 1 include pixels 10R, 10G1, 10G2 and 10B of 4 kinds (R: red, G1: green 1, G2: green 2 and B: blue), and p in the expression (A) is p=4. In the example shown in FIG. 5, green is classified into the pixels 10G1 and 10G2 of two kinds in order to widen a color range; however, typical three primary colors (R, G and B), that is, the pixels 10R, 10G and 10B of three kinds may be used. In the case where three primary colors are used, p is p=3. Only in the case of p=3, in particular, n in the expression (A) is preferably an integer of 2 or more. In the expression (A), px indicates a pixel pitch in the vertical direction (the X direction) of the two-dimensional display section 1, and py indicates a pixel pitch in the horizontal direction (the Y direction). N indicates the number of pixels in the Y direction included in one three-dimensional pixel 11. The “three-dimensional pixel” is one unit of pixel for displaying a spacial image, and a pixel group including a predetermined plural number of pixels of the two-dimensional display section 1 is set as one “three-dimensional pixel”. More specifically, a total number p×M×N (N and M each are an integer of 1 or more) of pixels 10 including a number N of pixels 10 in a horizontal direction and a p×M number of pixels 10 in a vertical direction is set as one “three-dimensional pixel”. Then, a number v₀ of light rays with different emission directions which are emitted from one three-dimensional pixel 11 at the same time satisfies the following expression:

v₀=p×M×N

In the example shown in FIG. 5, N in the horizontal direction and M in the vertical direction are set to be N=4 and M=4, respectively. Moreover, in the expression (A), n is an arbitrary integer, but once the number of n is determined, the number of n is not able to be changed in the same spacial image display system. In the example shown in FIG. 5, n is n=2. In the embodiment, the shape of the lenticular lens 2 is not specifically limited; but there is only one constraint. The constraint is that the pitch of the lenticular lens 2 is equal to the length in the X direction of the three-dimensional pixel 11. In other words, a lens pitch pr in the X direction of each cylindrical lens 2A in the lenticular lens 2 satisfies the following expression:

pr=p×px×M

The expression is not necessarily strictly satisfied, and it is only necessary to roughly satisfy the expression within a range where appropriate target display quality is satisfied.

The spacial image display according to the embodiment includes a displacement means for periodically changing relative positional relationship between each cylindrical lens 2A and each pixel 10 of the two-dimensional display section by reciprocating at least one of the lenticular lens 2 and the two-dimensional display section 1 on a plane substantially parallel to the display surface 1A so as to periodically displace the emission direction of display image light from each pixel 10 via each cylindrical lens 2A. Moreover, the spacial image display includes a control means for controlling images corresponding to a unit frame of a three-dimensional image to be time-dimensionally displayed on the two-dimensional display section 1, and controlling a timing of time-divisional display in the two-dimensional display section 1 to be cynchronized with a timing for changing relative positional relationship by the displacement means.

FIG. 3 shows circuit elements for performing the control. As shown in FIG. 3, the spacial image display includes an X driver (data driver) 33 supplying a driving voltage on the basis of a video signal to each pixel 10 in the two-dimensional display section 1, a Y driver (gate driver) 34 line-sequentially driving each pixel 10 in the two-dimensional display section 1 along a scanning line (not shown), a timing control section (timing generator) 31 controlling the X driver 33 and the Y driver 34, a video signal processing section (signal generator) 30 generating a time-division video signal by processing a video signal from outside, and a video memory 32 as a frame memory storing the time-division video signal from the video signal processing section 30.

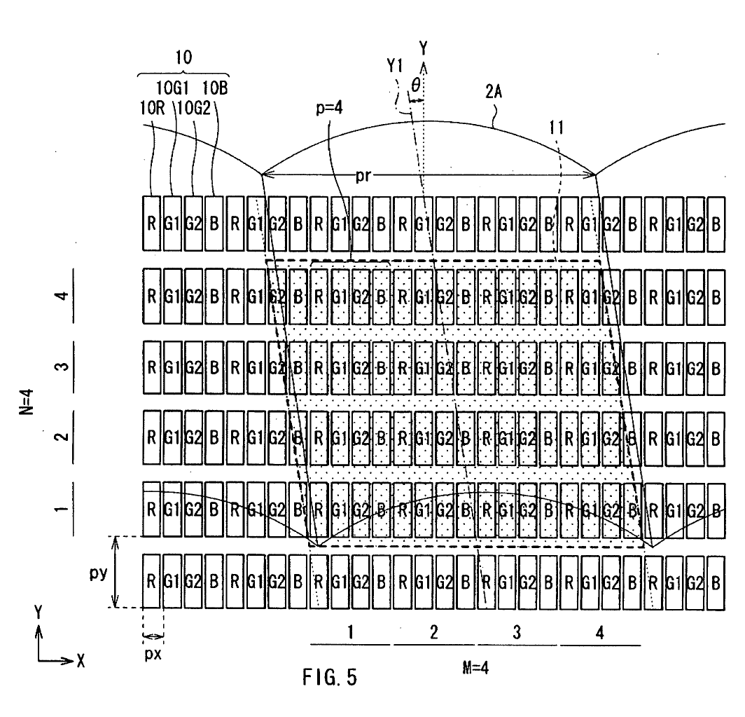

The video signal processing section 30 generates a time-division video signal which is time-divisionally switchable according to a plurality of viewing angles (deflection angles) with respect to one object on the basis of a video signal supplied from outside to supply the time-division video signal to the video memory 32. Moreover, the video signal processing section 30 supplies a predetermined control signal to the timing control section 31 so as to operate the X driver 33, the Y driver 34 and a piezoelectric control section 35 in synchronization with a timing of switching the time-division video signal. In addition, for example, as shown in FIG. 4, such a time-division video signal may be formed in advance by picking up images of an object 4 subjected to image pickup as an object to be displayed from various angles (corresponding to viewing angles).

The spacial image display also includes a piezoelectric device 21 corresponding to a specific example of the above-described “displacement means”. In the example shown in FIG. 3, the piezoelectric device 21 is arranged on the lenticular lens 2; however, in the spacial image display, as long as the lenticular lens 2 and the two-dimensional display section 1 are relatively moved so as to change relative positional relationship between the lenticular lens 2 and the two-dimensional display section 1, the piezoelectric device 21 may be arranged on the two-dimensional display section 1. Alternatively, the piezoelectric device 21 may be arranged on both of the lenticular lens 2 and the two-dimensional display section 1.

The spacial image display also includes the piezoelectric device control section 35 for controlling relative positional relationship displacement operation by the piezoelectric device 21. The piezoelectric device control section 35 supplies a control signal S1 for the relative positional relationship displacement operation to the piezoelectric device 21 according to timing control by the timing control section 31.

The timing control section 31 and the piezoelectric device control section 35 correspond to specific examples of the above-described “control means”.

The piezoelectric device 21 is arranged, for example, on a side surface of the lenticular lens 2, and is made of, for example, a piezoelectric material such as lead zirconate titanate (PZT). The piezoelectric device 21 changes the relative positional relationship between the two-dimensional display section 1 and the lenticular lens 2 according to the control signal S1 so that the relative positional relationship between two-dimensional display section 1 and the lenticular lens 2 reciprocates along an X-axis direction in an X-Y plane. Such relative positional relationship displacement operation by the piezoelectric device 21 will be described in detail later.

Next, the operation of the spacial image display configured in the above-described manner will be described below.

In the spacial image display, as shown in FIG. 3, a driving voltage (a pixel application voltage) from the X driver 33 and the Y driver 34 to the pixel electrode is supplied in response to the time-division video signal supplied from the video signal processing section 30. More specifically, for example, in the case where the two-dimensional display section 1 is a liquid crystal display device, a pixel gate pulse is applied from the Y driver 34 to gates of TFT devices on one horizontal line in the two-dimensional display section 1, and at the same time, a pixel application voltage on the basis of the time-division video signal is applied from the X driver 33 to pixel electrodes on one horizontal line. Thereby, backlight is modulated by a liquid crystal layer (not shown), and display image light is diverged from each pixel 10 in the two-dimensional display section 1, so as a result, a two-dimensional display image on the basis of the time-division video signal is formed by each pixel 10.

Moreover, the display image light emitted from the two-dimensional display section 1 is mostly converted into a parallel luminous flux by the lenticular lens 2 to be emitted. At this time, the piezoelectric device 21 changes the relative positional relationship between the two-dimensional display section 1 and the lenticular lens 2 in an X-Y plane according to switching of the time-division image signal in response to the control signal S1 supplied from the piezoelectric device control section 35. For example, the relative positional relationship is changed so that the lenticular lens 2 reciprocates along the X-axis direction. Thus, every time the time-division video signal is switched, relative positional relationship is changed according to the viewing angle of each viewer. Therefore, the display image light includes information about binocular disparity and a convergence angle, thereby an appropriate parallel luminous flux of display image light is emitted according to an angle (a viewing angle) at which a viewer sees, so a desired stereoscopic image according to an angle at which a viewer sees is displayed.

In the spacial image display, video signals (time-division video signals) according to a plurality of viewing angles with respect to one object are time-divisionally switched, so unlike a simple surface segmentation system in a related art, it is not necessary to include images corresponding to a plurality of viewing angles (deflection angles) in one two-dimensional image, so a decline in image quality (a decline in definition) is minimized, compared to the case of two-dimensional display. Moreover, the spacial image display is able to be manufactured without an MEMS technique or the like in a related art, so the spacial image display is easily obtainable. Further, the spacial image display is able to have a planar shape as a whole, so the spacial image display has a compact (thin-profile) configuration.

As described above, one characteristic in the embodiment is that while the displacement operation is performed on the relative positional relationship between the two-dimensional display section 1 and the lenticular lens 2, time-division images in synchronization with the displacement operation are projected from the two-dimensional display section 1 through the lenticular lens 2 to display a spacial image.

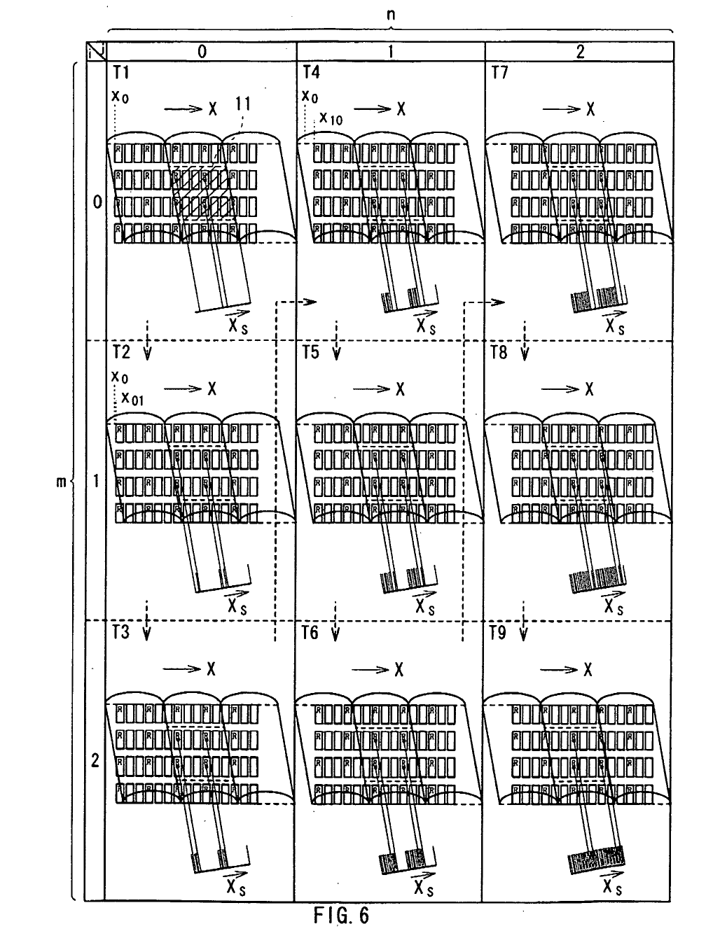

FIG. 6 shows timings at which time-division images are projected (displayed) from the two-dimensional display section 1. The timings at which the time-division images are projected from the two-dimensional display section 1 is set by the relative positional relationship between the two-dimensional display section 1 and the lenticular lens 2. Because of the relative positional relationship, the lenticular lens 2 or the display surface 1A of the two-dimensional display section 1 may be actually moved. FIG. 6 shows an example in which the display surface 1A of the two-dimensional display section 1 is moved in a vertical direction (the X direction) substantially in parallel to the fixed lenticular lens 2. Moreover, in the example shown in FIG. 6, the pixels 10 of the two-dimensional display section 1 include pixels 10R, 10G and 10B of three primary colors (R, G and B), that is, three kinds (p=3). Further, a pixel group formed from a matrix of a number N=2 of pixels in a horizontal direction by a number p×M=3×2 of pixels in a vertical direction constitutes one three-dimensional pixel 11.

At first, as shown by a state at T1 in FIG. 6, it is assumed that a position xo of the two-dimensional display section 1 is one timing for projecting an image from the two-dimensional display section 1.

Then, in the embodiment, when a value n×N in the above-described expression (A) is an integral multiple of p, a timing of another position at which an image is projected from the two-dimensional display section 1 is determined on the basis of the following expression (1). The expression is not necessarily strictly satisfied, and it is only necessary to roughly satisfy the expression within a range where appropriate target display quality is satisfied.

xij=xo+b0×i+a0×j (1)

where

i=0, . . . , (m−1), where m is an integer of 1 or more,

j=0, . . . , (n−1), where n is an integer of 1 or more,

a0=p×px/n

b0=a0/(N×m)

Moreover, when the value n×N in the expression (A) is not an integral multiple of p, the timing of another position at which an image is projected from the two-dimensional display section 1 is determined roughly on the basis of the following expression (2). The expression is not necessarily strictly satisfied, and it is only necessary to roughly satisfy the expression within a range where appropriate target display quality is satisfied.

xij=xo+b0×i+a0×j (2)

where

i=0, . . . , (m−1), where m is an integer of 1 or more,

j=0, . . . , (n−1), where n is an integer of 1 or more,

a0=(p×px)/n,

b0=px,

m=p

In the embodiment, assuming that xo is reference relative positional relationship between the lenticular lens 2 and the two dimensional display section 1, in the case where the value n×N is an integral multiple of p, the control means changes relative positional relationship xij between each cylindrical lens 2A and each pixel 10 of the two-dimensional display section 1 roughly according to the above-described expression (1), and controls the timing of time-divisional display in the two-dimensional display section 1 so as to be synchronized with a timing for changing the relative positional relationship xij according to the expression (1). Moreover, in the case where the value n×N is not an integral multiple of p, the control means controls on the basis of the above-described expression (2) instead of the expression (1).

FIG. 6 shows a tabular form about the timing of another position at which an image is projected from the two-dimensional display section 1 including relative positional relationship xo in an example in the case of the above-described expression (1), that is, about i and j in the expression (1) in an easily understandable way, and in FIG. 6, the positions of the two-dimensional display section 1 at i and j are shown using the position of the lenticular lens 2 which is fixed as a reference. FIG. 6 shows an example in the case where p=3, m=n=3 and N=M=2. As m=n=3 is established, i=0, 1, 2 and j=0, 1, 2 are established, so as a result, a table with 3 columns and 3 rows is formed.

A Merit in projecting an image from the two-dimensional display section 1 at such relative position timing will be described below, but as basic knowledge for easy understanding, a relationship between relative positional relationship between the lenticular lens 2 and a light-emitting point P1 on the display surface 1A of the two-dimensional display section 1 and the deflection direction of a light ray projected from the light-emitting point P1 will be described before describing the merit.

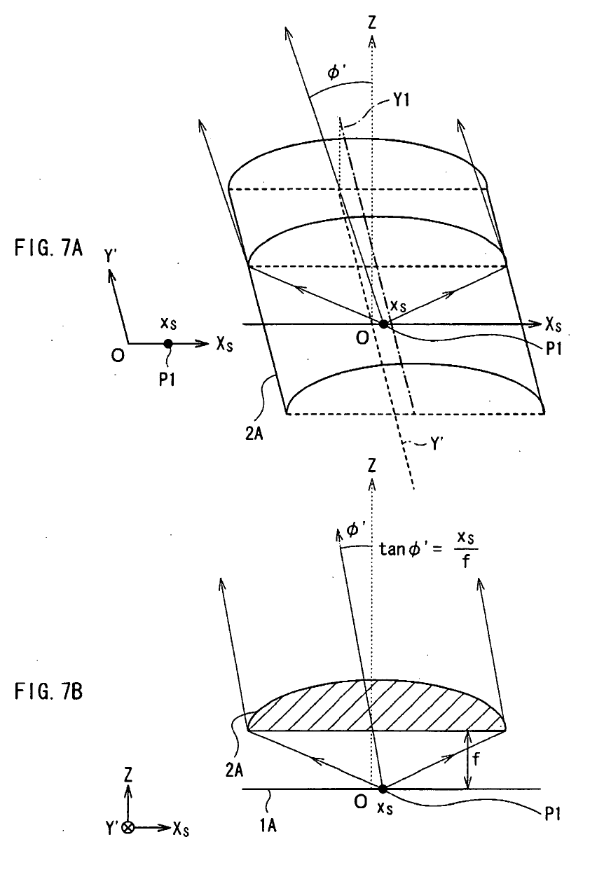

As shown in FIGS. 7A and 7B, when the light-emitting point P1 is arranged in the position of a focal length (an effective focal length: f) of the lenticular lens 2 (a cylindrical lens 2A of the lenticular lens 2), light emitted from the light-emitting point P1 is emitted, as a collimated light flux, in a direction perpendicular to a center line Y1 of the lenticular lens 2 (a cylindrical axis of the cylindrical lens 2A) and in a direction at a deflection angle φ′. When a projection line of a central axis line of the lenticular lens 2 is projected to a Y′-Xs plane (that is, the display surface 1A of the two-dimensional display section 1) on which the light-emitting point P1 is arranged, assuming that a distance from the light-emitting point P1 to a projection line Y′ is xs, a tangent of the deflection angle φ′ is roughly indicated by the following expression.

tan φ′=xs/f (3)

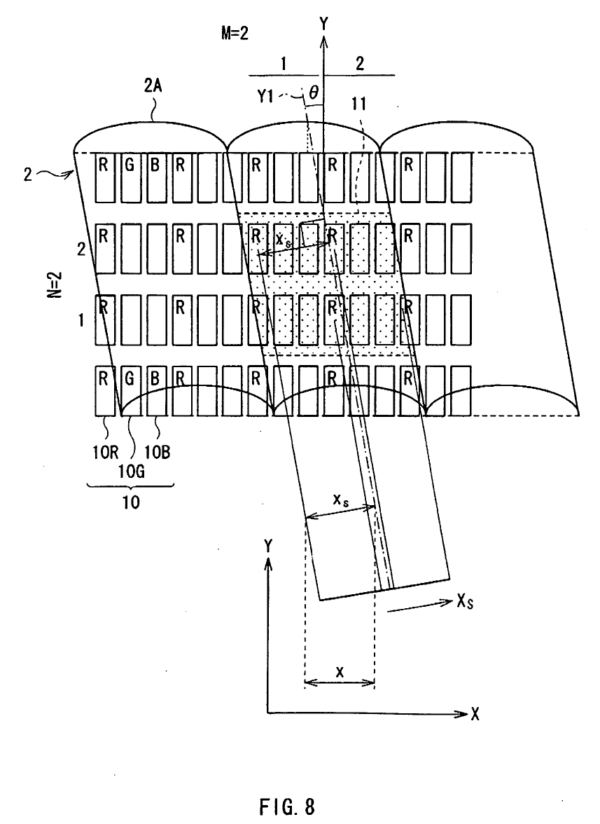

It is obvious from the expression (3) that the tangent of the deflection angle φ′ is proportional to the distance xs from the light-emitting point P1 to the line Y′ formed by projecting the center line Y1 onto a light-emitting point plane. FIG. 8 shows xs in an easily understandable manner. In the embodiment, pixels 10 of the two-dimensional display section 1 are arranged in a lattice form in the X and Y directions, and the central axis Y1 of the lenticular lens 2 is arranged at an angle θ with respect to a Y axis. An Xs axis is arranged in a direction perpendicular to the central axis Y1 (the projection line Y′ of the central axis Y1) of the lenticular lens 2 as shown in FIG. 8, and an original point O is arranged at a point where the center line of the lenticular lens 2 and xs intersect with each other. Thus, it is obvious that the distance xs from each pixel 10 to the center line Y1 of the lenticular lens 2 is a distance from a perpendicular line dropped from each pixel to the Xs axis to the original point O on the Xs axis. Then, the value of xs is a value proportional to the tangent of the deflection angle φ′.

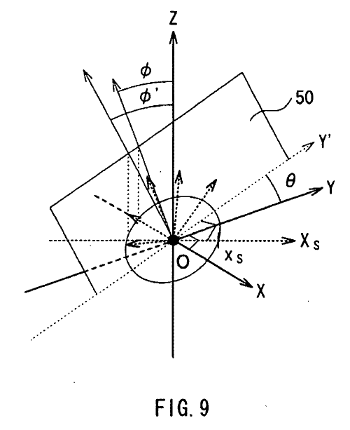

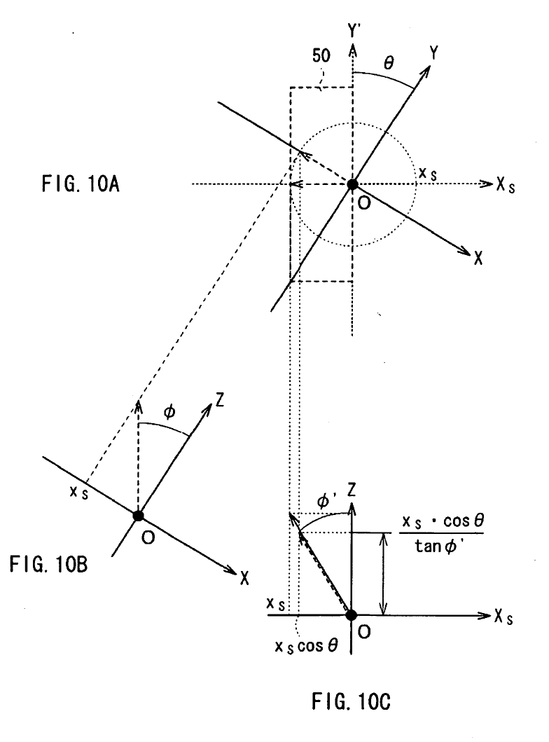

A deflection angle φ concerned in the embodiment is an angle which a light ray propagating in the above-described X-axis direction forms with an axis Z perpendicular to the display surface 1A of the two-dimensional display section 1, so it is necessary to describe φ using φ′. A relationship between φ and φ′ will be described referring to FIGS. 9 and 10A to 10C. At first, the display surface 1A of the two-dimensional display section 1 is arranged on an X-Y plane so that directions of the lattice of lattice-form pixels 10 of the two-dimensional display section 1 coincide with the X-axis direction and the Y-axis direction. The lenticular lens 2 is arranged thereon so that the center line of the lenticular lens 2 forms an angle θ with the Y axis.

In a bird's eye view in FIG. 9, the Y and X axes and the directional line (the projection line Y′) of the central axis Y1 of the lenticular lens 2 are shown. The case where light from the pixel 10 at the original point out of the pixels 10 of the two-dimensional display section 1 is emitted through the lenticular lens 2 is considered. An emission plane 50 shown in FIG. 9 has a shape of a luminous flux emitted from the pixel 10 at the original point O. As FIG. 9 shows a three-dimensional shape, it is difficult to understand; however, the emission plane 50 shown in FIG. 9 has the shape of a plate-like rectangle, and in a state in which a side of the rectangle coincides with a line segment (Y′) in a central line direction of the lenticular lens 2 passing through the original point O, the emission plane 50 has a shape in which the rectangular plane is slanted at φ from a Z axis perpendicular to an X-Y plane. At this time, a relationship between the angle φ which a light ray emitted in a direction along the X axis above an X axis line from the original point O forms with the Z axis and the angle φ′ which a light ray emitted in a direction along the Xs axis above an Xs axis line from the original point O forms with the Z axis is desired to be obtained. A drawing when the bird's eye view in FIG. 9 is viewed directly from the top in the Z-axis direction is a top view shown in FIG. 10A. The altitude from the Xs axis in the case where a light ray being emitted from the original point O and propagating along the Xs axis above the Xs axis propagates the distance xs along the Xs axis is established as below:

xs/tan φ′

Therefore, it is obvious from side views in FIGS. 10B and 10C that the altitude from the X axis in the case where a light ray being emitted from the original point O and propagating along the X axis above the X axis propagates a distance x is established as below:

(xs×cos θ)/tan φ′

Thereby, a relationship between φ and φ′ is established as below:

tan φ=tan φ′/cos θ

Moreover, a relationship between the tangent of φ and xs is obtained as below:

tan φ=xs×{1/(f×cos θ)} (4)

A relationship with x is x=xs×cos θ, so the following expression is established:

tan φ=x×{1/(f×cos² θ)} (5)

In other words, it is obvious that the tangent of φ is proportional to x or xs. This is the end of description about the basic knowledge for easy understanding.

Now, referring to FIG. 6, the merit in projecting an image from the two-dimensional section 1 at a relative position timing indicated by the expression (1) will be described below on the basis of the above-described basic knowledge.

Here again, FIG. 6 shows a tabular form about the timing of another position at which an image is projected from the two-dimensional display section 1 including the relative positional relationship xo in an example in the case of the expression (1) (that is, in the case where n×N is a multiple of p), that is, about i and j in the expression (1) in an easily understandable way, and in FIG. 6, the positions of the two-dimensional display section 1 at i and j are shown using the position of the lenticular lens 2 which is fixed as a reference. FIG. 6 shows an example in the case where p=3, m=n=3 and N=M=2. As m=n=3 is established, i=0, 1, 2 and j=0, 1, 2 are established, so as a result, a table with 3 columns and 3 rows is formed.

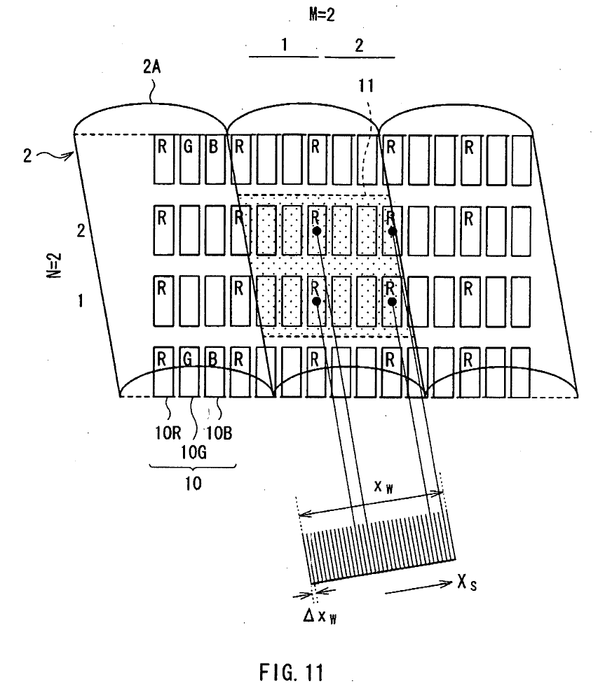

In the embodiment, the order of i and j is not specifically limited; however, it is desirable to project a predetermined image from the two-dimensional display section 1 under the same conditions and the same timing conditions in relative positional relationship in all cases of i and j. In FIG. 6, as shown in the drawing, each i and each j are scanned (relative positional relationship is changed) in a horizontal direction (i=0, 1 and 2) in order from the first line (T1→T2→ . . . →T9). At this time, attention is focused on “R pixels 11R” included in one arbitrary “three-dimensional pixel” 11 and, a drawing plotting scan position histories of the R pixel 11R in the Xs axis direction as bar line marks is added to FIG. 6. When scanning is performed in all cases, a state at a timing T9 is finally obtained. FIG. 11 shows an enlarged view of the state at the timing T9 in FIG. 6.

It is obvious from FIG. 11 that according to the conditional expression (1) (also the conditional expression (2)) in the embodiment, the scan history positions along the Xs axis direction of the pixel 10 (in this case, the R pixel 10R) on which attention is focused in an arbitrary “three-dimensional pixel” 11 are arranged at equal intervals (Δxw) in a width xw on the Xs axis, and the total number of the scan history positions is (N×M×m×n).

When the scan history positions of the pixel are arranged at equal intervals, it is obvious from the expression (4) that the tangent of the deflection angle φ is proportional to xs, so as a result of the above-described scanning, the tangents of the deflection angle φ are arranged at equal intervals. In other words, it is obvious that when an image is projected from the two-dimensional display section 1 at timings determined in the embodiment, only the number (N×M×m×n) of tangents of the deflection angle φ of light rays projected from the pixels 10 of a certain kind (in this case, the R pixels 10R) in the arbitrary “three-dimensional pixel” arranged on an arbitrary two-dimensional display section 1 are arranged at equal intervals. This corresponds to the number v of light rays with different emission directions emitted from one three-dimensional pixel 11 in a period of the unit frame of the three-dimensional image, or the number of viewpoints produced by one three-dimensional pixel in a period of the unit frame of the three-dimensional image.

The state is shown in FIGS. 1 and 2. In FIGS. 1 and 2, a state of light rays emitted from pixels 10 of a certain kind (for example, the R pixels 10R) in an arbitrary three-dimensional pixel 11 of the spacial image display is shown. It is assumed that a spacial image is viewed from a position at an arbitrary distance L from the spacial image display (on an X′-Y″ plane), and a viewer is able to freely move in parallel to a screen while keeping the distance L (for easy description, in this case, the viewer is able to move only to the right and the left while keeping the distance L; however, the distance L is freely set, so except for the description, the viewer is able to move back and forth and right and left to see an image). It is assumed that a point where a line (the Z axis) perpendicular to the center line Y1 of the lenticular lens 2 and the display surface 1A of the two-dimensional display section 1 intersects with the display surface 1A of the two-dimensional display section 1, and a point where the line (the Z axis) intersects with a line on which the viewer moves represent O and O′, respectively. When the pixels 10 of a certain kind (for example, the R pixels 10R) of the “three-dimensional pixel” 11 emit light at a relative position timing in the embodiment, in the case where the lenticular lens 2 is stopped, as shown in FIG. 2, the light-emitting points are arranged on the X axis at equal intervals, and then the tangents of the deflection angle φ are arranged at equal intervals from the above-described expression (5). Moreover, a light ray emitted from the light-emitting point P1 in a position at a distance x from O reaches a point at a distance x′ from O′ on the X′ axis indicated by the following expression (6). In this case, f is a focal length (an effective focal length) of the lenticular lens 2 (the cylindrical lens 2A of the lenticular lens 2).

x′=L×tan φ=x×{L/(f×cos² θ) (6)

It is obvious from the expression (6) that when the positions of the light-emitting points P1 on the X axis are arranged at equal intervals, the positions of reaching points when the light rays reach the X′ axis of the viewer at the distance L are arranged at equal intervals accordingly. The brightness when viewed from the viewer is proportional to the number of light rays entering into eyes of the viewer, so the fact that the positions of the reaching points are arranged at equal interval when the light rays reach the X′ axis means that even if the viewer sees an image in any position on the X′ axis, the intensity of light is the same, that is, variations in the intensity of light do not occur. Although description is given referring to, for example, the R pixels 10R, the same holds true for the pixels 10 of all kinds.

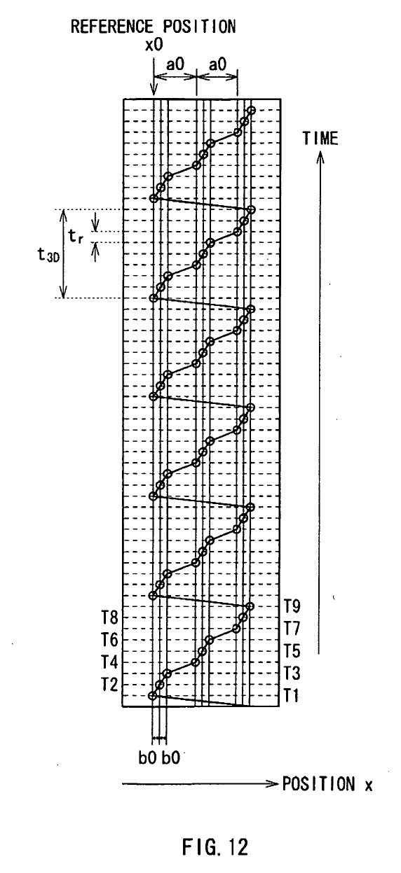

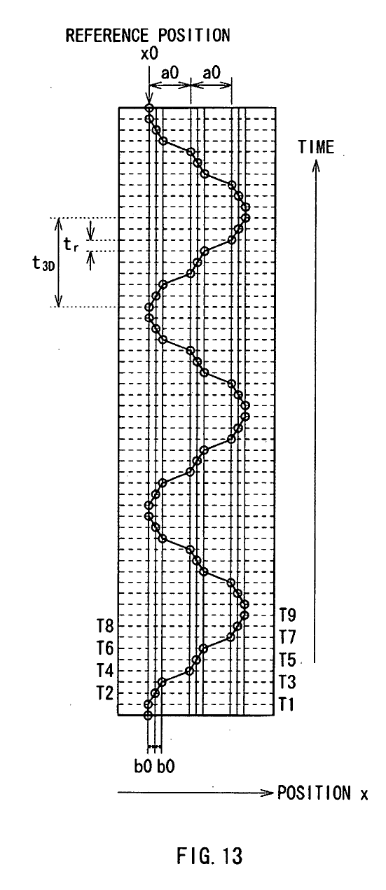

FIGS. 12 and 13 show examples of a scanning method for achieving the relative position timings shown in FIG. 6. In the embodiment, the order of timings in the expression (1) or the expression (2) is not specifically limited. Therefore, typically, the order of timings is determined by characteristics or conditions of a scan system. Moreover, the above-described expression shows relative positional relationship between the two-dimensional display section 1 and the lenticular lens 2, so the two-dimensional display section 1 or the lenticular lens 2 may be actually moved. In examples in FIGS. 12 and 13, the case where the lenticular lens 2 is moved is shown.

In particular, FIG. 12 shows an example in which scanning is performed (relative positional relationship is changed) in order of timings T1→T2→ . . . →T9 shown in the drawing in FIG. 6. In the example, scanning corresponding to a period of the unit frame of the three-dimensional image is performed by repeating one period from T1 to T9. Likewise, FIG. 13 shows an example in which the lenticular lens 2 is scanned in order of timings T1→T2→ . . . →T9 shown in the drawing in FIG. 6, but in the example, scanning is performed in order of T1→T2→ . . . →T9, and then scanning is performed in reverse order of T9→T8→ . . . →T1, and after that such a operation is repeated.

Characteristics of each example will be described below. In the example shown in FIG. 12, it is considered to select the timing when scanning is performed in one direction, and the example shown in FIG. 12 is suitable when being concerned about the hysteresis of the scan system. However, after scanning is performed in one direction, it is necessary for the scan system to return at high speed, so a scan system which is movable at high speed is necessary. On the other hand, in the example shown in FIG. 13, reciprocation of scanning is efficiently used, so the scanning speed may be minimum necessary, and a scan system with a relative low speed is suitable. However, when hysteresis is displayed in reciprocation, an issue such as a double image may occur, so a scan system with high position precision is demanded.

It is obvious from FIGS. 13 and 12 that an expression t3D=q×(m×n×tr) is desirably satisfied, where tr is a two-dimensional frame interval, representing a period of the unit frame of two-dimensional image in the two-dimensional display section 1, t3D is a three-dimensional frame interval, representing a period of the unit frame of three-dimensional image which emits the number v of light rays, and q is an integer of 1 or more.

By the way, xo in the expression (1) or (2) is a deflection offset, so xo is an arbitrary constant. Typically, when it is desired to perform symmetric deflection, it is desirable that assuming that a scanning amplitude peak is t0, the offset xo is set to a value equal to approximately a half of t0.

Moreover, in the embodiment, to secure the number v (=N×M×m×n) of light rays or viewpoints, it is preferable that the total number g representing a number of images to be two-dimensionally displayed in a period of the unit frame of three-dimensional image in the two-dimensional display section 1 preferably satisfies the following expression:

g=m×n≧2

This is the end of description that in the spacial image display according to the embodiment, when the timing for changing the relative positional relationship between the lenticular lens 2 and the two-dimensional display section 1 and the timing for two-dimensionally displaying images by the two-dimensional display section 1 are appropriately synchronously controlled, a viewer is able to see a spacial image without variations in light intensity.

Next, the description of how to be able to prevent color unevenness in the spacial image display according to the embodiment will be described below.

To reproduce a desired color through the use of one three-dimensional pixel 11 in the embodiment, it is necessary that the pixels 10 of colors such as R, G and B or R, G1, G2 and B emit light of colors with a predetermined light amount to mix colors, and a mixed color formed by mixing colors reaches the viewer. As a method of mixing colors from the pixels 10 of colors, there is a method in which the pixels 10 of colors emit light in temporally parallel to mix colors, and a method in which the pixels 10 of colors serially emit light with a predetermined light amount in a short time to mix colors through the use of an integral function of human eyes. In the embodiment, light is emitted mainly in parallel and series; however, a characteristic point for reproducing a desired color by mixing light from the pixels 10 of colors through the use of the three-dimensional pixel 11 is that in the case where attention is focused on light rays emitted from one three-dimensional pixel 11 in a predetermined deflection direction, it is necessary to equally emit light rays with a predetermined light amount in a predetermined deflection direction from the pixels 10 of all kinds such as R, G and B or R, G1, G2 and B in the above-described three-dimensional frame interval t3D.

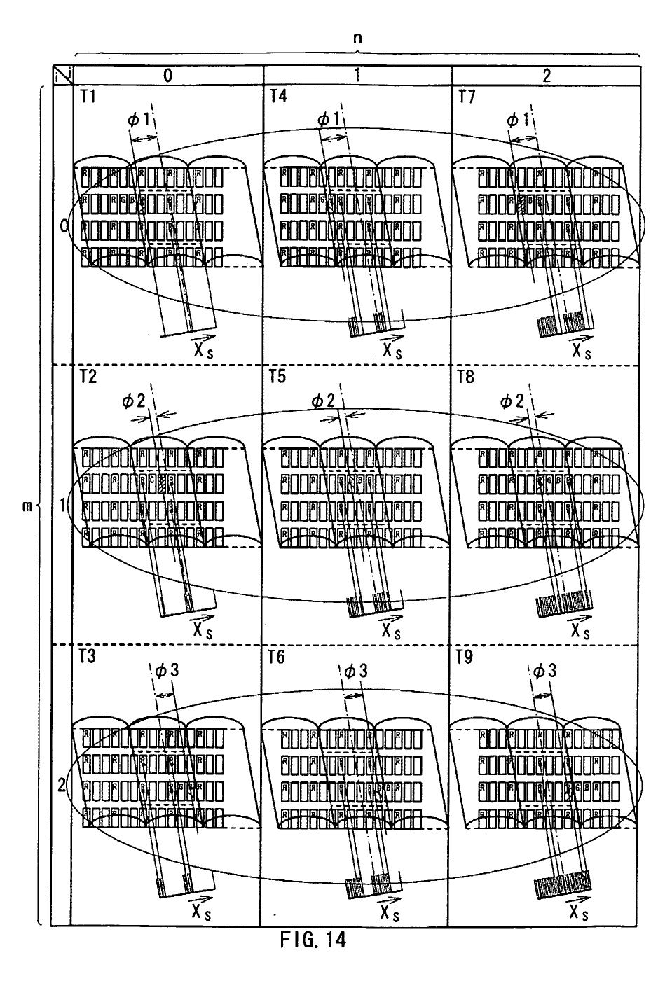

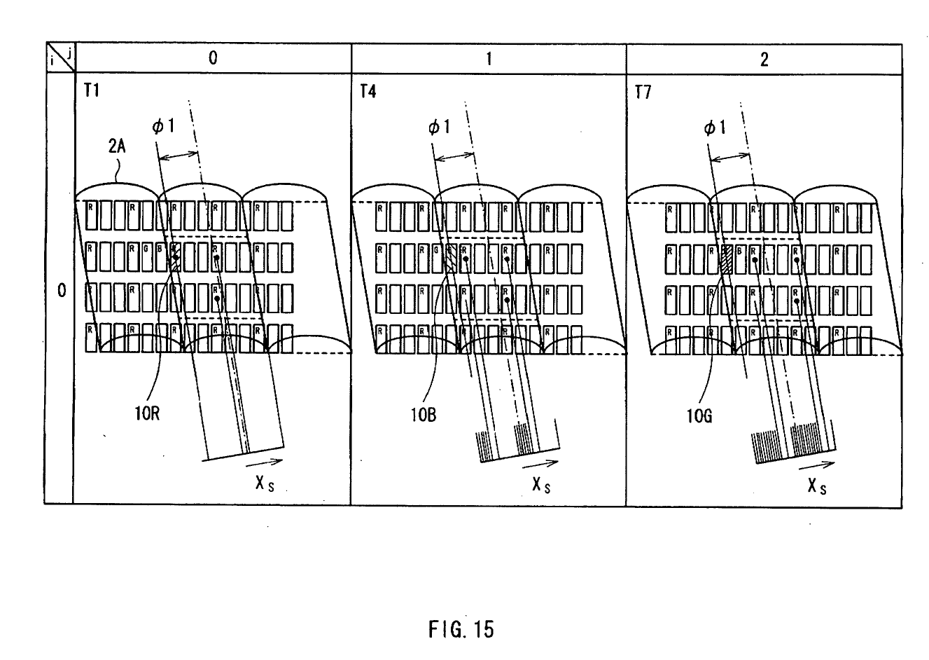

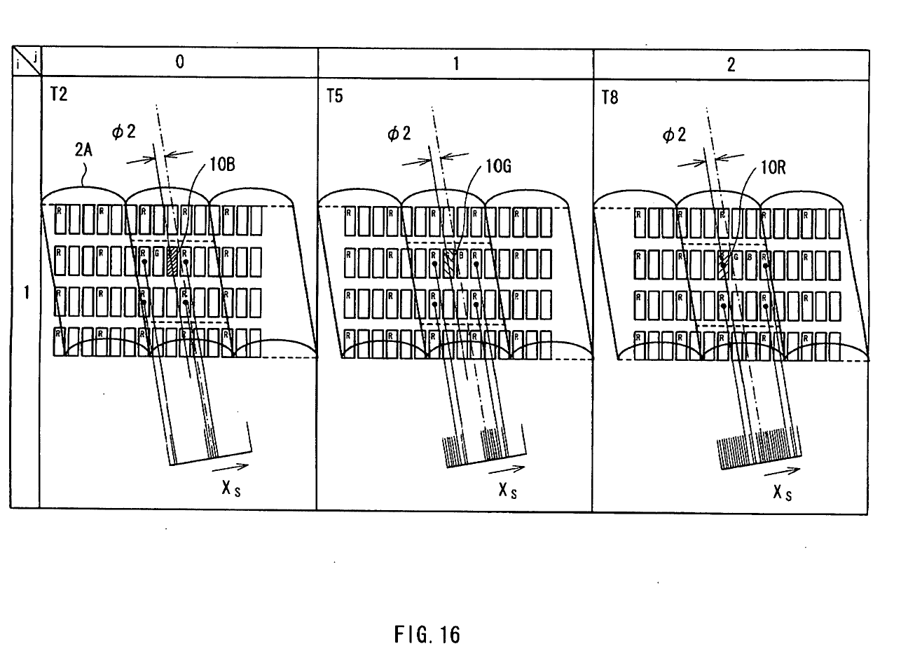

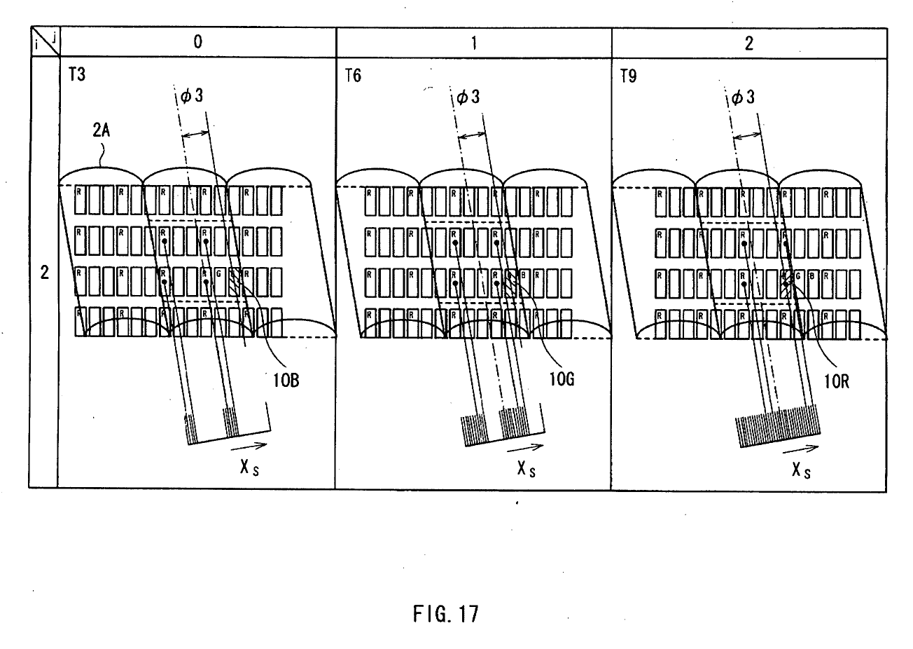

In the embodiment, when attention is focused on light rays emitted from one three-dimensional pixel 11 in a predetermined deflection direction, light rays with a predetermined light amount are equally emitted from the pixels 10 of all kinds such as R, G and B or R, G1, G2 and B in a predetermined deflection direction in the three-dimensional frame interval t3D to prevent color unevenness. This will be described below referring to FIG. 14. FIG. 14 is basically the same drawing as FIG. 6. Moreover, display states at the timings T1, T4 and T7 in FIG. 14 is enlargedly shown in FIG. 15. Further, display states at the timings T2, T5 and T8 are enlargedly shown in FIG. 16, and display states at the timings T3, T6 and T9 are enlargedly shown in FIG. 17.

In the case where pixels 10 have three kinds of R, G and B, light rays may be emitted from the pixels 10 of all kinds, that is, R, G and B in a direction to a focused deflection angle in the three-dimensional frame interval t3D. For example, it is shown that in the case where a deflection angle φ1 shown in FIG. 14 is focused, a light ray is emitted from the R pixel 10R in a state at the scanning timing T1 which constitutes one “three-dimensional frame”, and a light ray is emitted from a B pixel 10B at the timing T4, and a light ray is emitted from a G pixel 10G at the timing T7 (the state is enlargedly shown in FIG. 15).

Moreover, it is shown that in the case where a deflection angle φ2 is focused, a light ray is emitted from the B pixel 10B in a state at the scanning timing T2 which constitutes one “three-dimensional frame”, and a light ray is emitted from the G pixel 10G at the timing T5, and a light ray is emitted from the R pixel 10R at the timing T8 (the state is enlargedly shown in FIG. 16).

Further, it is shown that in the case where a deflection angle φ3 is focused, a light ray is emitted from the B pixel 10B in a state at the scanning timing T3 which constitutes one “three-dimensional frame”, and a light ray is emitted from the G pixel 10G at the timing T6, and a light ray is emitted from the R pixel 10R at the timing T8, (the state is enlargedly shown in FIG. 17).

As shown in the above-described example, in the embodiment, light rays are equally emitted from the pixels 10 of all kinds, that is, R, G and B in a predetermined deflection direction in the three-dimensional frame interval. Therefore, color unevenness is able to be prevented.

As described above, in the spacial image display according to the embodiment, the two-dimensional display section 1 including a plurality of pixels 10 of p colors and the lenticular lens 2 slanted with respect to the pixel array are appropriately combined, thereby a plurality of light rays corresponding to a plurality of viewing angles are emitted into space at the same time by surface segmentation. Moreover, when the relative positional relationship between each cylindrical lens 2A and each pixel 10 of the two-dimensional display section 1 is periodically changed, the emission direction of display image light from each pixel 10 via each cylindrical lens 2A is periodically displaced. Then, images corresponding to a unit frame of a three-dimensional image are time-divisionally displayed by each pixel 10 of the two-dimensional display section 1, and the timing of time-divisional display in the two-dimensional display section 1 and the timing for changing the relative positional relationship by the displacement means are synchronously controlled. In other words, in the spacial image display according to the embodiment, stereoscopic display with a combination of the surface segmentation system and the time division system is able to be achieved. Moreover, time-divisional display is achieved by moving the lenticular lens 2 or the two-dimensional display section 1 as a whole; therefore, for example, compared to the case where micromirrors in a deflection micromirror array are time-divisionally, independently and synchronously controlled, synchronous control is easier. Thereby, stereoscopic display with higher definition than that in a related art is able to be easily achieved. Further, when suitable synchronous control satisfying a predetermined expression is performed, intensity variations in the brightness of a spacial image and color unevenness are prevented, and a spacial image is displayed more favorably.

### Second Embodiment

Next, a second embodiment of the invention will be described below. Like components are denoted by like numerals as of the first embodiment, and will not be further described.

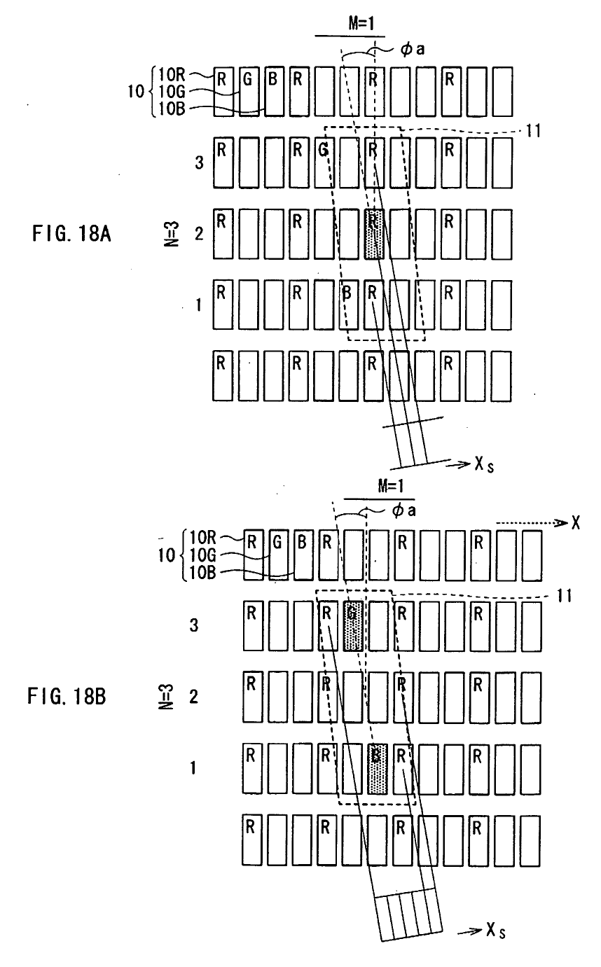

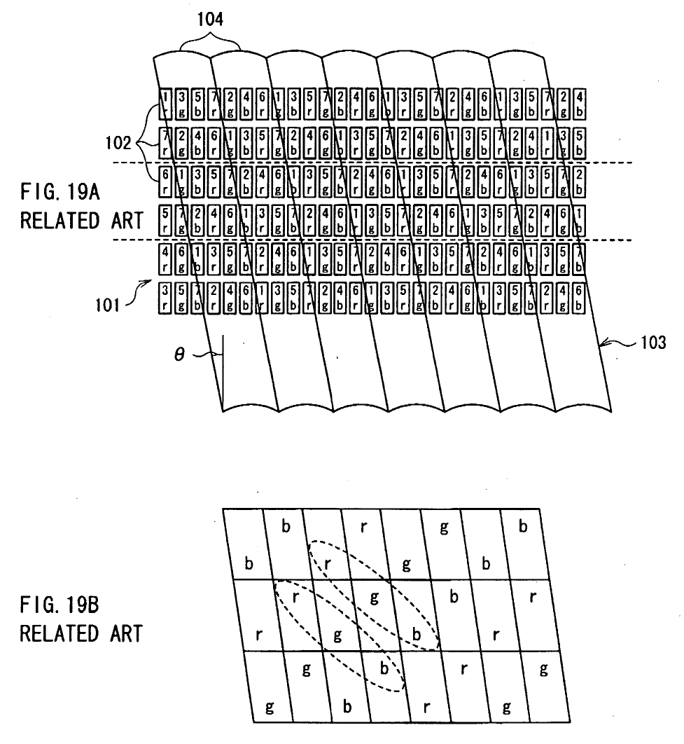

In the first embodiment, it is obvious from the example shown in FIG. 14 that the pixels 10 of all kinds, that is, R, G and B are arranged in order in a focused position in the three-dimensional pixel 11 by the scanning operation (an operation of changing the relative positional relationship), color unevenness is prevented. On the other hand, FIGS. 18A and 18B show display examples in a spacial image display according to the embodiment. The spacial image display according to the embodiment has the same basic configuration as that of the spacial image display according to the first embodiment, except that the system of scanning operation is different.

In the embodiment, two states shown in FIGS. 18A and 18B constitute one three-dimensional frame. When a part where the deflection angle is φa is focused as an example, in a first state shown in FIG. 18A, light from the R pixel 10R is emitted, and in a second state shown in FIG. 18B, light from G pixel 10G and light from the B pixel 10B are emitted at the same time. In other words, it is obvious that light from the pixels 10 of each color, that is, R, G and B is emitted from one three-dimensional pixel 11 in one “three-dimensional frame” at the deflection angle φa. It is obvious that in the examples shown in FIGS. 18A and 18B which are slightly different from the example shown in FIG. 14, the pixels 10 of R, G and B are arranged in a different position in the three-dimensional pixel 11. However, as long as light is emitted from pixels 10 in one three-dimensional pixel 11 in the same direction, even if the positions of the pixels 10 in the three-dimensional pixel 11 are different, colors from the pixels are able to be mixed.

It should be understood by those skilled in the art that various modifications, combinations, sub-combinations and alterations may occur depending on design requirements and other factors insofar as they are within the scope of the appended claims or the equivalents thereof.

What is claimed is:

1. A spacial image display emitting, into space, a plurality of light rays corresponding to a plurality of viewing angles to form a three-dimensional spacial image, the spacial image display comprising:
a two-dimensional display section including a plurality of pixels of p colors (p is an integer of 1 or more), the pixels being two-dimensionally arranged on a lattice in a horizontal direction and a vertical direction to form a planar display surface, a plurality of pixels of the same color being arranged in the horizontal direction, a plurality of pixels of p colors being periodically arranged in the vertical direction so that the same color appears at a certain period;
a lenticular lens, with a plate shape as a whole, including a plurality of cylindrical lenses arranged in parallel so that cylindrical axes of the cylindrical lenses are parallel to one another, the lenticular lens facing a display surface of the two-dimensional display section so as to be parallel to the display surface as a whole, the cylindrical axes of the cylindrical lenses being slanted at a predetermined angle with respect to an axis in the horizontal direction of the two-dimensional display section in a plane parallel to the display surface, each of the cylindrical lenses deflecting display image light from each pixel of the two-dimensional display section to emit the display image light;
a displacement means for reciprocating at least one of the lenticular lens and the two-dimensional display section in a plane parallel to the display surface to periodically change relative positional relationship between each of the cylindrical lenses and each of the pixels of the two-dimensional display section, thereby to periodically displace the emission direction of display image light from each pixel via each of the cylindrical lenses; and
a control means for controlling images corresponding to a unit frame of a three-dimensional image to be time-divisionally displayed on the two-dimensional display section, and controlling a timing of time-divisional display to be synchronized with a timing for changing the relative positional relationship by the displacement means.

2. The spacial image display according to claim 1, wherein
a pixel group, formed from a N by p×M matrix of pixels and including a total number p×M×N of pixels, configures a three-dimensional pixel, where N and M are integers of 1 or more which represent numbers of pixels arranged in the vertical direction and the horizontal direction in the two-dimensional display section, respectively, and
an angle between the vertical direction in the two-dimensional display section and a direction of the cylindrical axis of the lenticular lens satisfies an expression (A):
θ=tan⁻¹{(p×px)/(n×N×py)} (A)
where n is an integer of 1 or more, px is a pixel pitch in the horizontal direction of the two-dimensional display section, and py is a pixel pitch in the vertical direction of the two-dimensional display section.

3. The spacial image display according to claim 2, wherein
a number v which is a number of light rays with different emission directions emitted from one three-dimensional pixel in a period of the unit frame of three-dimensional image, or a number of viewpoints produced by one three-dimensional pixel in a period of the unit frame of three-dimensional image, satisfies an expression v=m×n×(M×N), where m is an integer of 1 or more.

4. The spacial image display according to claim 2, wherein
a number v₀ of light rays with different emission directions emitted from one three-dimensional pixel at the same time, satisfies an expression v₀=p×M×N.

5. The spacial image display according to claim 3, wherein
a total number g of images necessary to secure the number v of light rays or viewpoints, the total number g representing a number of images to be time-divisionally displayed in a period of the unit frame of three-dimensional image in the two-dimensional display section, satisfies an expression g=m×n≧2.

6. The spacial image display according to claim 1, wherein
a lens pitch pr in the horizontal direction of the cylindrical lenses in the lenticular lens satisfies an expression pr=p×px×M.

7. The spacial image display according to claim 2, wherein
a value n in the expression (A) is, in particular, an integer of 2 or more, only in the case of p=3.

8. The spacial image display according to claim 2, wherein
the displacement means allows the lenticular lens or the two-dimensional display section to be reciprocated in the horizontal direction of the two-dimensional display section,
a value n×N in the expression (A) is an integral multiple of p and,
the control means changes relative positional relationship xij between each of the cylindrical lenses and each pixel of the two-dimensional display section according to an expression (1), and controls a timing of time-divisional display in the two-dimensional display section to synchronized with a timing for displacing a relative positional relationship xij:
xij=xo+b0×i+a0×j (1)
where
xo is a relative reference position between the lenticular lens and the two-dimensional display section,
i=0, . . . , (m−1), where m is an integer of 1 or more,
j=0, . . . , (n−1), where n is an integer of 1 or more,
a0=(p×px)/n and
b0=a0/(N×m)

9. The spacial image display according to claim 2, wherein
the displacement means allows the lenticular lens or the two-dimensional display section to be reciprocated in the horizontal direction of the two-dimensional display section,
a value n×N in the expression (A) is not an integral multiple of p, and
the control means displaces relative positional relationship xij between each of the cylindrical lenses and each pixel of the two-dimensional display section according to an expression (2), and controls a timing of time-divisional display in the two-dimensional display section to be synchronized with a timing for changing the relative positional relationship xij:
xij=xo+b0×i+a0×j (2)
where
xo is a relative reference position between the lenticular lens and the two-dimensional display section, i=0, . . . , (m−1), where m is an integer of 1 or more,
j=0, . . . , (n−1), where n is an integer of 1 or more,
a0=(p×px)/n
b0=px
m=p

10. The spacial image display according to claim 3, wherein an expression t3D=q×(m×n×tr) is satisfied,
where
tr is a two-dimensional frame interval, representing a period of the unit frame of two-dimensional image in the two-dimensional display section,
t3D is a three-dimensional frame interval, representing a period of the unit frame of three-dimensional image which emits the number v of light rays, and
q is an integer of 1 or more.

11. A spacial image display emitting, into space, a plurality of light rays corresponding to a plurality of viewing angles to form a three-dimensional spacial image, the spacial image display comprising:
a two-dimensional display section including a plurality of pixels of p colors (p is an integer of 1 or more), the pixels being two-dimensionally arranged on a lattice in a horizontal direction and a vertical direction to form a planar display surface, a plurality of pixels of the same color being arranged in the horizontal direction, a plurality of pixels of p colors being periodically arranged in the vertical direction so that the same color appears at a certain period;
a lenticular lens, with a plate shape as a whole, including a plurality of cylindrical lenses arranged in parallel so that cylindrical axes of the cylindrical lenses are parallel to one another, the lenticular lens facing a display surface of the two-dimensional display section so as to be parallel to the display surface as a whole, the cylindrical axes of the cylindrical lenses being slanted at a predetermined angle with respect to an axis in the horizontal direction of the two-dimensional display section in a plane parallel to the display surface, each of the cylindrical lenses deflecting display image light from each pixel of the two-dimensional display section to emit the display image light;
a displacement section reciprocating at least one of the lenticular lens and the two-dimensional display section in a plane parallel to the display surface to periodically change relative positional relationship between each of the cylindrical lenses and each of the pixels of the two-dimensional display section, thereby to periodically displace the emission direction of display image light from each pixel via each of the cylindrical lenses; and
a control section controlling images corresponding to a unit frame of a three-dimensional image to be time-divisionally displayed on the two-dimensional display section, and controlling a timing of time-divisional display and a timing for changing the relative positional relationship by the displacement section.
